(19) United States
(12) Patent Application Publication
(10) Pub. No.: US 2004/0133365 A1
(43) Pub. Date: Jul. 8, 2004

(54) Method of determining forces and torques acting on a riding vehicle

(76) Inventors: Stefan A. Drumm, Saulheim (DE); Peter E. Rieth, Eltville (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/701,275

(22) Filed: Nov. 4, 2003

(30) Foreign Application Priority Data
Nov. 5, 2002 (DE) 10251343.0
Dec. 4, 2002 (DE) 10256556.2

(51) Int. Cl. G01L 1/00

(52) U.S. Cl. 702/41

(57) ABSTRACT

The present invention relates to a method of determining forces and torques acting on a riding vehicle. The invention is characterized in that measuring signals from acceleration sensors are evaluated which are fitted, preferably in longitudinal, transverse and vertical alignment, to one or more selected points on the vehicle, and that other signals are evaluated which represent the spatial angular velocity of the vehicle and its time derivative (rolling, pitching and/or yaw velocity and rolling, pitching and/or yaw acceleration) or at least some of these variables, and that a mathematic model of the vehicle is provided in which forces and torques acting on the vehicle or at least selected components of these forces and torques are determined from the sensor signals.

### TECHNICAL FIELD

The present invention relates to a method of determining forces and torques acting on a riding vehicle.

### BACKGROUND OF THE INVENTION

A vehicle body can be modeled as a rigid body. Using such a model, the body's motion in space is sensed by means of acceleration sensors and yaw rate sensors. Mass geometry of the vehicle is assumed to be sufficiently known and can be determined more precisely by means of identification methods. This renders it possible to reconstruct, on the basis of the sensor signals, the total force \vec{F} and the total torque \vec{T}_{A} with respect to a plotted point of the vehicle, which cause the sensed motion. With respect to a system of coordinates according to DIN 70000 fitted to the vehicle in point A, \vec{F} and \vec{T}_{A} are decomposed into the components longitudinal force Fₓ, transverse force F_{y}, vertical force F_{z}, rolling moment T_{Ax}, pitching moment T_{Ay} and yaw torque T_{Az}. The total force and total torque acting on a vehicle are caused by the wheel forces, that means the contact forces transmitted in the contact of tires on the roadway and by aerodynamic forces and torques during normal driving maneuvers (without trailer or similar accessories). The points of application of the wheel forces are known in approximation (apart from compression movements which can either be ignored, assessed or measured), and the torques about the vertical axis transmitted in the individual tire contact area may be ignored in driving maneuvers. The result is nine contact force components {Fᵥₗₓ, F_{vly}, F_{vlz}, Fᵥᵣₓ, F_{vry}, F_{vrz}, Fₕₗₓ, F_{hly}, F_{hlz}, Fₕᵣₓ, F_{hry}, F_{hrz}}. The effect of aerodynamic forces can be modeled by means of an aerodynamic longitudinal force Fₐₓ and an aerodynamic pitching moment T_{ay}. Further variables can be added if aerodynamic vehicle asymmetries and/or side wind and/or a trailer's load are to be taken into consideration. These eleven variables (or more) are in a mathematical relation with the six total force and torque variables. Therefore, it is impossible to resolve the corresponding equations into individual contact force components and aerodynamic force/torque variables without additional information. Wheel compression travels are e.g. feasible as additional information.

The determined force or torque variables are used in driving dynamics control systems. It is the objective of systems of this type to take a positive effect on the motion of a vehicle for enabling the driver to better master it. Knowing about the contact forces makes it significantly easier to achieve this object.

In some questions relating to driving dynamics, however, it is unnecessary to know about all of the force and torque components listed. Selected sums of force components will suffice depending on the problem. For example, the two transverse forces of the wheels of one axle have the same line of application. Therefore, they appear only as a sum in the motion equations of the total vehicle. The same applies to the longitudinal forces of each vehicle side when the track is identical on the front and rear axles. Accordingly, the number of variables under review will reduce. Furthermore, it is not necessary to review the complete spatial motion equations for each problem related to driving dynamics. Thus, in a particularly favorable embodiment or improvement of the invention, the question about an imminent risk of rollover of the vehicle under review may be answered without needing additional information. It will be sufficient to this end to determine the respective sums of the tire contact forces F_{lz}=F_{vlz}+F_{hlz} and F_{rz}=F_{vrz}+F_{hrz} of one vehicle side. An imminent risk of the vehicle rolling over to the side is given exactly when the sum of the tire contact forces of one vehicle side approaches zero. The imminent risk of rollover about the longitudinal axis of the vehicle can thus be determined directly by determining the respective sum of the right and left tire contact forces. So far suggestions aimed at directly measuring the four tire contact forces. Force sensors are, however, technically complicated (DE 196 23 595 A1=P 8708 CT) and expensive. Therefore, it is difficult to market them with small-size motor vehicles. Another prior art solution involves assessing tire contact forces from the wheel compression travels. This is, however, possible only for stationary compressions because in contrast to the force exerted by the easy-to-model spring, the force exerted by the chassis damper in dynamic compression and rebound motions cannot be calculated at a sufficient rate of accuracy from the compression signals in view of changes of the damper parameters as a result of temperature, ageing, transverse force effects, etc.

In view of the above, an object of the present invention is to indirectly determine the wheel forces or at least selected sums of components of these wheel forces, such as the respective sums of the tire contact forces on both vehicle sides, by means of low-cost sensors suited for series production.

This object is achieved by the invention in that a generic method is so implemented that measuring signals from acceleration sensors are evaluated which are fitted, preferably in longitudinal, transverse and vertical alignment, to one or more selected points on the vehicle and that other signals are evaluated which represent the spatial angular velocity of the vehicle and its time derivative, in particular the rolling, pitching and/or yaw velocity and the rolling, pitching and/or yaw acceleration, or at least some of these variables, and that a mathematic model of the vehicle is provided in which forces and torques acting on the vehicle or at least selected components of these forces and torques are determined from the sensor signals. To this end, it is favorably possible to determine e.g. the imminent risk of rollover by means of conventional sensors. In this case, meaning, when only part of the force information is required, the need for some of the vehicle motion sensors is eliminated.

Advantageously, other sensors determining at least the roll angle velocity or roll angle acceleration are so designed that at least one of the other signals is the measuring signal of a yaw rate sensor fitted to the vehicle.

It is also favorable that at least one of the other signals comprises a model-based logical operation of the measuring signals of several acceleration sensors, which are fitted to at least two different points on the vehicle.

It is still further favorable that wheel forces or at least selected components of the wheel forces or at least selected sums of wheel force components are calculated from the determined forces and torques that act on the vehicle, if necessary, with the aid of further information about the driving-dynamics condition of the vehicle. To reduce the number of computing operations, wheel force components or sums of wheel force components are calculated directly from the measuring signals, thereby founding on the previously described correlation between the wheel force components and the vehicle forces and vehicle torques.

In addition, it is favorable that for determining an imminent risk of rollover of the vehicle at least one transverse acceleration signal, one vertical acceleration signal and one roll angle velocity signal are processed in the mathematic vehicle model.

It is expedient that at least one sum of tire contact forces for the left side and one other sum of tire contact forces for the right side of the vehicle is determined. The method can be implemented in such a fashion that the acceleration sensors u_{z}, u_{y} measure the vertical and transverse accelerations, and other sensors measure variables which represent directly or in model-based manner the roll angle velocity and the roll angle acceleration, and that a model is provided in which sums of tire contact forces of the left and right vehicle side are determined from the measuring signals.

The method at topic is suitable for detecting rollover maneuvers in four-wheel vehicles, wherein rollover of the vehicle is identified or forecast when the sum of the tire contact forces of one vehicle side falls below a threshold at the current point of time or in a time extrapolation of the determined course of signals relating to the sum of forces.

Further advantages of the method of the invention are explained in detail by way of an example of detecting the imminent risk of rollover.

With an imminent risk of rollover, it is possible to indirectly determine contact forces between tire and roadway or at least selected sums of components of these contact forces, in particular the sums of contact forces per side that are relevant to judge the imminent risk of rollover, by means of low-cost sensors appropriate for series production. To this end, the motion of the vehicle body is sensed, and simplified motion equations for the vehicle are used to determine forces and torques that act on the vehicle and are responsible for said motion. Advantageously, the other sensors that determine the variables roll angle velocity or roll angle acceleration are designed as yaw rate sensors.

From the measured accelerations, angular velocities and angular accelerations it is determined in the model according to the invention which forces and torques that act on the vehicle body induce the vehicle motion sensed. The tire contact force components sought or their sums are computed from these variables. It is, of course, possible to mathematically eliminate the intermediate operation of calculating the total force and total torque from the computation procedure in order to render computation procedures more compact. If, as in the present case, only the side-wise sums of the tire contact forces are required, it is sufficient to determine only the components F_{y}, F_{z} und T_{Ax} from the spatial quantities total force

\vec{F}=Fₓ\vec{e}ₓ+F_{y}\vec{e}_{y}+F_{z}\vec{e}_{z} (1)

and total torque

\vec{T}_{A}=T_{Ax}\vec{e}ₓ+T_{Ay}\vec{e}_{y}+T_{Az}\vec{e}_{z} (1)

The knowledge about the forces and torques allows determining rollover maneuvers of four-wheeled vehicles, and rollover of the vehicle is detected or forecast when the determined sum of tire contact forces of one vehicle side falls under a threshold or will fall under said threshold in the near future.

The above-noted method provides important state information for all driving dynamics control interventions—no matter whether within the limits of ABS, TCS or ESP and, in particular, control interventions intended to prevent vehicle rollover in a driving maneuver—with the determined tire contact forces and the forces horizontally applied to the roadway. Force sensors are not required for this purpose.

### BRIEF DESCRIPTION OF THE DRAWING

FIG. 1 shows a representation of force ratios of a vehicle during a cornering maneuver.

### DETAILED DESCRIPTION OF THE PREFERRED EMBODIMENTS

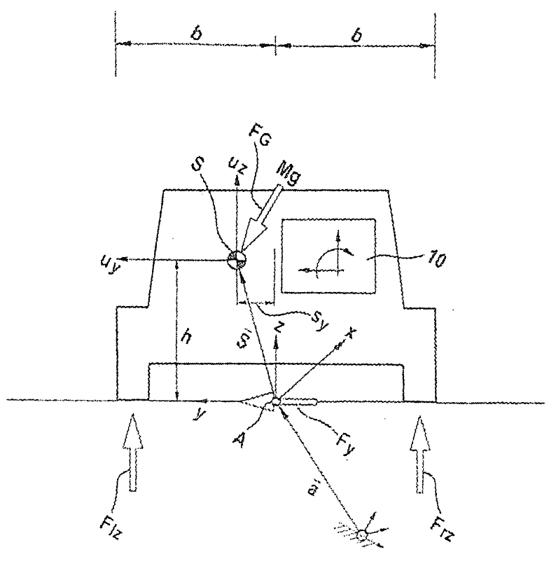

Now referring to FIG. 1, the offset of the center of gravity S from the vehicle center is referred to as s_{y}, the level of the center of gravity above the roadway is designated by the letter h.

To determine the sums of tire contact forces F_{lz} and F_{rz} and the sum of transverse force F_{y}, the vehicle is looked at as a rigid body in a simplified two-dimensional model, onto which body only the contact forces between tire contact area and roadway act beside the gravitational force. Aerodynamic forces and the movement of vehicle parts relative to a system of coordinates (x, y, z) on the vehicle moved along with the vehicle body, such as the rotation and compression of the vehicle wheels, may be ignored in this context. A rigid body moves under the effect of applied forces and torques according to generally known mathematical interrelationships, i.e. center-of-mass law and an extended form of the Euler equations for the angular motion of especially rigid bodies giving the spatial angular momentum vector equation. After having detected the state of motion of the rigid body, it is possible to use these motion equations to make conclusions with respect to the acting forces and torques. The right-hand and left-hand sums of tire contact forces F_{lz}, F_{rz} sought are computed from the vehicle's state of motion.

It shows in a simplified modeling of the vehicle that is reduced to the plane normal to vehicle's longitudinal direction that the vertical acceleration u_{z} and transverse acceleration u_{y}, as well as the roll angle velocity φ and roll angle acceleration φ are sufficient as measuring signals to determine the left-hand and right-hand tire contact forces sought. Additionally, the sum F_{y} of the transverse forces exerted by the roadway to the tires is achieved. The state of motion in the system on the vehicle is measured. To this end, the sensors should be fixed to the vehicle, meaning, they should not be kept in a spatial alignment, constant in time, by means of a gyro-stabilized platform. Instead of the mentioned sensor signals, any other sensor configuration may, of course, be chosen, from the signals of which the above-mentioned signals can be computed. In particular, the measuring point and the alignment of the sensors may be chosen relatively freely, they only need to be on the vehicle and sense motions in all directions necessary for computation. It is also possible to use further acceleration sensors instead of the angular velocity sensors. In this case, however, the sensors must be distributed onto at least two measuring points on the vehicle that are placed as far as possible in their projection to the modeling plane.

What is taken into account in the calculation of the forces from the sensor signals for judging the imminent risk of rollover is, on the one hand, the geometry of the sensor assembly which is defined by the position of the sensors in the vehicle and, on the other hand, wheelbase and track b which can also be assumed as being known, and finally the mass parameters of the vehicle composed of total mass M, position of the center of gravity S, and mass inertia tensor \ddot{Θ}_{A}. The mass parameters can change only slowly, compared to the variables of the system under review such as sensor data and forces, apart from abrupt changes, such as load slipping to one side. Therefore, they are first not known, yet accessible to an identification for which forces are also required apart from the acceleration data anyway available. In contrast to the above noted highly dynamic force measuring signals, however, assessed values are sufficient for this identification, which can be determined from the compression travels during quasi-stationary motional phases of the vehicle.

The mass as a parameter may be obviated when the forces are e.g. normalized to the weight of the vehicle. The vehicle mass M is thereby omitted in the equations, and mass geometry is taken into consideration in the system of coordinates of the vehicle only in the form of center-of-gravity position, inertia radii and the position of the inertia ellipsoid.

Of course, it is not possible to calculate each individual force that acts on the body by means of the method described hereinabove because forces that are applied along the same line of application will appear only as a sum in motion equations and, consequently, only their sum can be determined. Thus, it is impossible to conclude the individual transverse forces at the left and right front wheel from a sum of the transverse forces determined for the front wheels by way of the vehicle's state of motion.

In the two-dimensional modeling of the vehicle that will be described in the following, the disclosed method allows the highly dynamic determination of the left-hand and right-hand sums of tire contact forces and the sum of the transverse forces with respect to the vehicle. This feature also permits the time extrapolation of the determined force signals and the forecast of the time when a vehicle side will lift. The knowledge of the motion equations and the state of motion of the vehicle model enables in addition optimal control interventions for avoiding rollover in the way of braking and steering interventions.

Other acceleration signals and a pitching and yaw rate signal may be used in a completely spatial modeling of the vehicle.

FIG. 1 shows the simplified two-dimensional model of the vehicle for determining the tire contact forces and the transverse force in the y-z plane. The following approach may be taken to derive the computation guide of the invention:

Spatial linear momentum vector equation:

M(\vec{a}+\vec{s}{umlaut over ())}=\vec{F} (3)

Spatial angular momentum vector equation (generalized form of the Euler equations)

[symbol]

_{A}\vec{ω}+ [symbol] [symbol] _{A}\vec{ω}+M [symbol] \vec{ä}=\vec{T}_{A} (4)

Kinematics of rigid bodies

\vec{s}= [symbol] \vec{s}, \vec{\ddot{s}}=( [symbol] + [symbol] ²)\vec{s} (5)

Reduction to two dimensions (2D):

\vec{s}=0\vec{e}ₓ+s_{y}\vec{e}_{y}+s_{z}\vec{e}_{z} (6)

\vec{ω}=\dot{φ}\vec{e}ₓ+0\vec{e}_{y}+0\vec{e}_{z} (7)

[symbol]

\vec{\ddot{s}}=\ddot{φ}\vec{e}ₓ×(s_{y}\vec{e}_{y}+s_{z}\vec{e}_{z})+\dot{φ}²\vec{e}ₓ×(\vec{e}ₓ×(s_{y}_{y}+s_{z}\vec{e}_{z}))

\vec{\ddot{s}}=\ddot{φ}(s_{y}\vec{e}_{z}−s_{z}\vec{e}_{y})+\dot{φ}²(−s_{y}\vec{e}_{y}−s_{z}\vec{e}_{z})

\vec{\ddot{s}}=(−\ddot{φ}s_{z}−\dot{φ}²s_{y})ë_{y}+(\ddot{φ}s_{y}−\dot{φ}²s_{z})\vec{e}_{z} (8)

& [symbol] [symbol] [symbol] _{A}\vec{ω}=\vec{0} (9)

& [symbol] [symbol] \vec{ä}=(s_{y}ä_{z}−s_{z}ä_{z})\vec{e}ₓ+(s_{zä}ₓ−sₓä_{z})\vec{e}ₓ+(s_{z}äₓ−sₓä_{z})\vec{e}_{y}+(sₓä_{y}−s_{y}äₓ)\vec{e}_{z} (10)

Inserting 8, 9, 10 in 3, 4 results in:

Mä_{z}+M(\ddot{φ}s_{y}−\dot{φ}²s_{z})=F_{lz}+F_{rz}+Mg_{z} (11)

Mä_{y}+M(−\ddot{φ}s_{z}−\dot{φ}²s_{y})=F_{y}+Mg_{y} (12)

[symbol]

\ddot{φ}+M(s_{y}ä_{z}−s_{z}ä_{y})=b(F_{lz}−F_{rz})+M(s_{y}g_{z}−s_{z}−g_{y}) (13)

Acceleration sensors do not measure \vec{a}, but \vec{a}-\vec{g}.

Therefore, transformation of 11, 12, and 13 to

M(ä_{z}−g_{z})+M(\ddot{φ}s_{y}−\dot{φ}²s_{z})=F_{lz}+F_{rz} (14)

M(ä_{y}−g_{y})+M(−\ddot{φ}s_{z}−\dot{φ}²s_{y})=F_{y} (15)

[symbol]

\ddot{φ}+M(ä_{z}−g_{z})s_{y}−M(ä_{y}−g_{y})s_{z}=b(F_{lz}−F_{rz}) (16)

A combination of acceleration sensors fitted in the vehicle center at the level h (that means in the center of gravity S) and aligned in the directions of coordinates y and z provides the following sensor signals:

u_{y}=ä_{y}−g_{y}−h\ddot{φ} (17)

u_{z}=ä_{z}−g_{z}−h\dot{φ}² (18)

It should be noted in this respect that it is not imperative to mount the acceleration sensors in the center of the vehicle, and even less in the vehicle's center of gravity. The assumption of a measuring point (plotted point A) in the vehicle center chosen herein leads to particularly simple formulas, however. It is known to the expert in the art how the sensor signals from other places of installation and also from orientations different from the axes of coordinates must be converted with respect to the signals used herein.

Inserting 17, 18 in 14, 15, 16 results in

M(u_{z}+h\dot{φ}²)+M(\dot{φ}s_{y}−\dot{φ}²s_{z})=F_{lz}+F_{rz} (19)

M(u_{y}+h\dot{φ})+M(−\dot{φ}s_{z}−\dot{φ}²s_{y})=F_{y} (20)

[symbol]

\ddot{φ}+M(u_{z}+h\dot{φ}²)s_{y}−M)u_{y}+h\ddot{φ})s_{z}=b(F_{lz}−F_{rz}) (21)

Resolving this linear equation system in terms of the contact forces results in

$$\begin{matrix}2 \frac{{F}_{lz}}{M} = ( {s}_{y} - \frac{h}{b} {s}_{z} + \frac{ϑ}{b M} ) \ddot{ϕ} + ( - {s}_{z} + h + \frac{h}{b} {s}_{y} ) {\dot{ϕ}}^{2} - \frac{{s}_{z}}{b} {u}_{y} + ( 1 + \frac{{s}_{y}}{b} ) {u}_{z} & ( 22 ) \\ 2 \frac{{F}_{rz}}{M} = ( {s}_{y} + \frac{h}{b} {s}_{z} - \frac{ϑ}{b M} ) \ddot{ϕ} + ( - {s}_{z} + h - \frac{h}{b} {s}_{y} ) {\dot{ϕ}}^{2} + \frac{{s}_{z}}{b} {u}_{y} + ( 1 - \frac{{s}_{y}}{b} ) {u}_{z} & ( 23 ) \\ \frac{{F}_{y}}{M} = ( h - {s}_{z} ) \ddot{ϕ} - {s}_{y} {\dot{ϕ}}^{2} + {u}_{y} & ( 24 )\end{matrix}$$

The tire contact forces F_{lz} and F_{rz} and the sum of the transverse forces F_{y} transmitted in the contact with the roadway can be determined from the acceleration sensor signals u_{z}, u_{y} and the roll angle velocity signal \dot{φ}, and the roll angle acceleration \ddot{φ} is also employed. As an alternative, it is possible to use instead of the directly measured roll angle velocity other sensor signals from which the required angular velocity information can be determined, for example in a model-based manner.

The equations 22, 23 and 24 can be combined to the linear equation system

$$[ \begin{matrix}{F}_{lz} \\ {F}_{rz} \\ {F}_{y}\end{matrix} ] = [ \begin{matrix}{K}_{11} & {K}_{12} & {K}_{13} & {K}_{14} \\ {K}_{21} & {K}_{22} & {K}_{23} & {K}_{24} \\ {K}_{31} & {K}_{32} & {K}_{33} & {K}_{34}\end{matrix} ] \cdot [ \begin{matrix}\ddot{ϕ} \\ {\dot{ϕ}}^{2} \\ {u}_{y} \\ {u}_{z}\end{matrix} ] , \qquad ( 25 )$$

and the measuring matrix K_{i,j} that is constant in time depends on the sensor position, the coordinates of the center of gravity, the vehicle mass, and the moment of mass inertia. This matrix imparts the interrelationship between the sought force variables F_{lz}, F_{rz} und F_{y} and the directly or indirectly measurable motional quantities \ddot{φ}, \dot{φ}², u_{y} and u_{z}.

Symbols:

\vec{e}ₓ, \vec{e}_{y}, \vec{e}_{z} vehicle-related, therefore time-variable unit vectors

in x, y and z-direction

A plotted point (vehicle center)

S center of gravity of the vehicle

\vec{a} radius vector origin of coordinates—plotted point

\vec{s} position vector plotted point—center of gravity

\vec{g} acceleration due to gravity

\vec{F} sum of forces acting on the vehicle

Fₓ, F_{y}, F_{z} x, y, and z-component of \vec{F}

\vec{T}_{A} sum of the torques acting on the vehicle with respect to the plotted point A

T_{Ax}, T_{Ay}, T_{Az} x−, y, and z component of \vec{T}_{A}

F_{vlX} x-component of the wheel force, front left

F_{vly} y-component of the wheel force, front left

F_{vlZ} z-component of the wheel force, front left

Fᵥᵣₓ x-component of the wheel force, front right

F_{vry} y-component of the wheel force, front right

F_{vrz} z-component of the wheel force, front right

Fₕₗₓ x-component of the wheel force, rear left

F_{hly} y-component of the wheel force, rear left

F_{hlz} z-component of the wheel force, rear left

Fₕᵣₓ x-component of the wheel force, rear right

F_{hry} y-component of the wheel force, rear right

F_{hrz} z-component of the wheel force, rear right

Fₐₓ aerodynamic longitudinal force

T_{ay} aerodynamic pitching moment

M vehicle mass 0

0 [symbol] mass inertia moment tensor of the vehicle with respect to the plotted point A

\vec{ω}_{A} angular velocity vector of the vehicle

φ (P roll angle

\dot{φ} roll angle velocity

\ddot{φ} roll angle velocity

x cross product

F_{lz}=F_{lvz}+F_{lhz} sum of tire contact forces, left

F_{rz}=F_{rvz}+F_{rhz} sum of tire contact forces, right

F_{y}=F_{lvy}+F_{lhy}+F_{rvy}+F_{rhy} sum of transverse forces

mass inertia moment for the vehicle with a rolling motion with respect to the plotted point A

s_{y} x-component of the center-of-gravity position in relation to plotted point A

s_{z} z-component of the center-of-gravity position in relation to the plotted point A

g_{y} x-component of the acceleration due to gravity

g_{z} z-component of the acceleration due to gravity

b half of vehicle track

u_{y} sensor signal of transverse acceleration sensor

u_{z} sensor signal of vertical acceleration sensor

1. Method of determining forces and torques acting on a riding vehicle,
characterized in that measuring signals from acceleration sensors are evaluated which are fitted, preferably in longitudinal, transverse and vertical alignment, to one or more selected points on the vehicle, and that other signals are evaluated which represent the spatial angular velocity of the vehicle and its time derivative, in particular the rolling, pitching and/or yaw velocity and the rolling, pitching and/or yaw acceleration, or at least some of these variables, and that a mathematic model of the vehicle is provided in which forces and torques acting on the vehicle or at least selected components of these forces and torques are determined from the sensor signals.

2. Method as claimed in claim 1,
characterized in that at least one of the other signals is the measuring signal of a yaw rate sensor fitted to the vehicle.

3. Method as claimed in claim 1,
characterized in that at least one of the other signals comprises a model-based logical operation of the measuring signals of several acceleration sensors, which are fitted to at least two different points on the vehicle.

4. Method as claimed in any one of claims 1 to 3,
characterized in that wheel forces or at least selected components of the wheel forces or at least selected sums of wheel force components are calculated from the determined forces and torques that act on the vehicle, if necessary, with the aid of further information about the driving-dynamics condition of the vehicle.

5. Method as claimed in any one of claims 1 to 3 and claim 4,
characterized in that for reducing the number of computing operations, wheel force components or sums of wheel force components are calculated directly from the measuring signals, thereby founding on the correlation between the wheel force components and the vehicle forces and vehicle torques described in claim 4.

6. Method as claimed in any one of claims 1 to 5,
characterized in that for determining an imminent risk of rollover of the vehicle at least one transverse acceleration signal, one vertical acceleration signal and one roll angle velocity signal is processed in the mathematic vehicle model.

7. Method as claimed in claim 6,
characterized in that at least one sum of tire contact forces for the left side and another sum of tire contact forces for the right side of the vehicle is determined.

8. Method of determining rollover maneuvers in vehicles with four wheels,
characterized by the features as claimed in any one of claims 1 to 7, wherein rollover of the vehicle is identified or forecast when the sum of the tire contact forces of one vehicle side falls below a threshold at the current point of time or in a time extrapolation of the determined course of signals relating to the sum of forces.
